(19) United States
(12) Patent Application Publication
(10) Pub. No.: US 2018/0238635 A1
(43) Pub. Date: Aug. 23, 2018

(54) THERMAL DEVICE FOR A FLUID, WITH BAFFLES, AND ASSOCIATED CIRCUITS

(71) Applicant: HUTCHINSON, Paris (FR)

(72) Inventors: Fabrice Chopard, Paris (FR); Paul Bline, Paris (FR); Boris Chauvet, Paris (FR); Christophe Dominiak, Paris (FR)

(73) Assignee: Hutchinson, Paris (FR)

(21) Appl. No.: 15/753,784

(22) PCT Filed: Aug. 19, 2016
(86) PCT No.: PCT/FR2016/052094

§ 371 Date: Feb. 20, 2018

(30) Foreign Application Priority Data
Aug. 20, 2015 (FR) 1557837

(51) Int. Cl. F28D 20/02; B60H 1/32; F01M 5/02; F01M 11/00; F01P 11/20

(52) U.S. Cl. CPC F28D 20/023; F28D 20/026; B60H 1/3202; F28D 2020/0078; F01M 11/0004; F01P 11/20; F01M 5/021

(57) ABSTRACT

A thermal device comprising a fluid circulation circuit in which the fluid circulates over time at different temperatures, and a thermal store and heat exchanger arranged on said circuit and enclosing an interior volume in which the fluid circulates, and in which are arranged elements that store and release thermal energy, of PCM type, in contact with the fluid, for heat exchanges. The interior volume of the store and heat exchanger is provided with baffles.

This application is a national stage International Application No. PCT/FR2016/052094, filed Aug. 19, 2016, which claims the benefit of French Patent Application 1557837, filed Aug. 20, 2015, the contents of each of which are incorporated herein by reference.

The present invention, in particular, relates to a thermal device for a refrigerant or heat transfer fluid.

Such a device already exists. EP 0076884 or US 2005/167169 has one of them, which comprises, like the one from the present application:
a circuit in which a fluid circulates over time at different temperatures,
a thermal store and heat exchanger arranged on said circuit and enclosing an interior volume in which the fluid circulates between an inlet and an outlet, and in which are arranged elements having PCM (phase change material) that store and release thermal energy, in contact with the fluid which circulates, for a heat exchange between each other,

It is specified that a phase change material—or PCM—will mean any material capable of changing physical state in a limited temperature range. The heat storage can take place by using the Latent Heat (LH) thereof: the material can thus store or transfer energy by simply changing state, while preserving a substantially constant temperature, that of the state change.

Yet, the industry is asked to accelerate the placing on the market of new technologies which could reduce pollutant emissions, smooth out possible specific increases in loads in relation to a nominal sizing functioning, but also to propose solutions to stagger the release, over time, of energy available at another time.

Yet, PCMs, in their current implementation, in particular so as to produce the structural environment in which they are arranged, do not seem to be able to meet the expectations of the market.

An efficiency of the heat rate in the exchange within the store and heat exchanger and therefore an industrial implementation, specific to enabling to adapt the store and heat exchanger to the needs of the client (exchange rate/capacity by volume/bulk) are met.

It is therefore in this context that it is proposed here that the thermal device presented above is such:
of modular construction, the store and heat exchanger comprises several adjacent modules, structurally separate and of which at least some individually comprise a base, separating two adjacent modules, each base:
   splitting the volume into a succession of sub-volumes in which are distributed elements that store and release around and/or wherein the fluid circulates, in heat exchanges with each other,
   and having at least one communication passage between the sub-volumes,
and, to create, in the store/exchanger, baffles on the fluid path:
   communication passages between the sub-volumes are offset from one passage to the next one, and/or
   inside the module in question, and to create other sub-volumes here, partitions are developed which maintain communications between said other sub-volumes, for the circulation of the fluid.

The term “baffles” is to be understood as indicating the presence in the store and heat exchanger of means which oppose the natural progression of the fluid in said interior volume, by ensuring a certain turbulence to this fluid then in heat exchange with said elements that store and release energy. These baffles can, in particular, impose on the fluid, in the store/exchanger, a circulation path which will weave, such as a zig-zag path.

Relating to what is outlined above, it is also proposed that the elements that store and release thermal energy are individualised structures that have exterior surfaces formed to keep a space between them, in which a fluid can circulate.

Even then, the implementation of these elements will facilitate (handling/storage/production/maintenance/adaptation to needs), along with the rate of heat exchanges.

Controlling the heat exchanges between the/each interior volume of the store and heat exchanger and the exterior of the device has also been considered.

Once again, to be able to control the expected efficiency of the heat exchanges, internal to the device, in particular, within the/each interior volume, it is recommended:
that the store and heat exchanger has at least one peripheral wall interposed between the (each) interior volume of the exterior, and
that the device further comprises at least one first layer containing a PCM and at least one second layer containing a heat-insulating material which will surround said interior volume, in order to ensure the heat management thereof.

The thermally-insulating material of the second layer will not, therefore, be a PCM, but an insulator, such as a glass wool, a porous insulator, a polyurethane or polyisocyanurate foam, or even more favourably, a porous thermally-insulating material arranged in a vacuum chamber, to define at least one vacuum insulation panel, VIP.

Also, it is proposed that the thermally-insulating material is porous and that at least the second layer containing this thermally-insulating material is contained in an envelope sealed to said material and airtight, such that with an air gap being created in said material, a VIP panel is constituted.

The thermally-insulating material of the second layer will have a lower thermal conductivity than the PCM.

With a VIP (vacuum insulation panel), the efficiency of the heat management will be optimised, even the whole weight decreased in relation to another insulator.

By “VIP”, this means a vacuum partial air structure (internal pressure between 10 and 10⁴ Pa) containing at least one thermally-insulating material, porous in principle.

“Porous” here will mean a material that has gaps enabling air to pass. Porous materials, with open cells, therefore include foams, but also fibrous materials (such as glass wool or rock wool). The passage gaps that can be qualified as pores are smaller than 1 or 2 mm, and preferably smaller than 1 micron, and more preferably, smaller than 10⁻⁹ m (nanoporous structure), for specific questions regarding ageing and therefore, possibly weaker depression in the VIP envelope.

Actually, the VIP panels used will preferably be thermal insulators, in which porous material cores, for example, a silica gel or silicic acid powder (SiO2), will be able to have been flattened and each surrounded, under vacuum, by a gas-tight surrounding sheet, for example, made from a plastic and/or laminated aluminium material. The gap obtained, with a residual pressure which can be less than 1 mbar, will enable to favourably lower the thermal conductivity to less than around 0.015/0.020 W/(m·K) under conditions of use.

Yet, in at least some applications or functioning applications to be anticipated, it can be necessary to reach a thermal insulation efficiency via said “second layer”, in particular superior to that of more conventional insulating materials, such as those mentioned above. Typically, a thermal conductivity λ of less than 0.008/0.01 W/m·K can be expected.

Concerning these VIP panels, it has further been noted that in addition, they do not seem to meet the market expectations up to now. In particular, their implementations in the field is a problem, in particular, their processing.

Also, it is proposed:
that said at least one peripheral wall separating from outside, the (each known) interior volume of the device contains a mouldable polymer material,
and that the first and second layers are integrated with said polymer material (in other words, arranged in said peripheral wall).

Countersinking the first and second layers in the polymer material should be considered as a favourable solution.

Regarding this thermal management around the internal volume(s), in which the storage and heat exchanges are carried out between said elements housed there and the fluid circulating along them, it is proposed, for the reasons stated below:
that said peripheral wall belongs to an exterior protective casing surrounding all the store and heat exchanger modules and which will integrate or will be lined by the first and/or second layer(s) mentioned above,
and/or that each one of said modules comprises said peripheral wall which will therefore integrate or will be lined by said first and/or second layer(s).

The first option will enable to individualise the thermal management of the store and heat exchanger and to adapt the base solution more easily, here presented in the current industrial environment of clients, with their immediate bulk limitations, of producing structures surrounding or completing the present device.

The second option will facilitate the modularity and a mainly series production of the store and heat exchanger and therefore the longer-term development of the solution stated here.

In addition to the device which has just been presented, here in particular, two industrial applications are concerned (although not exclusively):

In the first application, the circuit mentioned above is a circuit for cooling, by a heat transfer liquid, such as water, an engine in a vehicle, the circuit comprising a liquid circulation path and, arranged on the path:
in series, a means for circulating the liquid, an engine of which the components are to be placed in a heat exchange with the liquid and a radiator that has an inlet and an outlet for said liquid, in order to place in heat exchange with another fluid,
assembled on a first branch, between the inlet and the outlet of the radiator, the thermal store and heat exchanger stated above, with all of part of the characteristics thereof.

In this case, it can be useful, in a developed version, that in the protective casing, a connection column for the fluid, extends outside of the modules and is equipped with valves.

Thus, modularity, rate efficiency and industrial production will be associated mainly in series of the store/exchanger, with the first option and therefore the longer-term development of said second solution stated here.

In the second application, a thermal device is proposed, to respond to the problems above, therefore for a refrigerant or heat transfer fluid, the device comprising a circulation circuit, in which a fluid circulates over time at different temperatures, and which, on a vehicle engine, is a lubrication circuit whereon are arranged, in fluid communication, functional components of the engine to be lubricated, a lubricant crankcase (engine sump) and a thermal store and heat exchanger, which includes:
an interior volume, in which the lubricant circulates, between an inlet and an outlet, and in which are arranged elements having PCM, which store and release thermal energy,
and, in said interior volume, partitions which split the volume into a succession of sub-volumes with communications between them, for the circulation of baffles of the lubricant, around and/or in the elements that store and release thermal energy, which are distributed in the sub-volumes, for thermally exchanging with the lubricant.

Favourably:
at least some of the functional components of said engine will be located in an engine block,
the lubricant crankcase will be screwed to the engine block, under it, and will contain the lubricant, and
the thermal store and heat exchanger will be arranged in the lubricant crankcase, for sending the lubricant to the engine block, after it has circulated in said thermal store and heat exchanger.

Thus, a single structure will be created to be directly returned under the engine block.

But, as explained later, there can be problems with bulk or volume imposed by a manufacturer.

That is why, it can advantageously be provided:
that, in the lubricant crankcase, with the circulation of lubricant having stopped, said elements that store and release said thermal energy are immersed in a first lubricant volume (V1) outside of which a second lubricant volume (V2) superior to the first volume (V1) will lay,
even that at least the second layer containing the thermally-insulating material, thus porous, is contained in an enveloped sealed to said material and airtight, such that with an air gap being created in said envelope, a VIP panel is constituted.

Such a volume V2/V1 ratio, typically between 1.1 and 1.5, associated with the baffling and the peripheral thermal management provided will enable the aim to be achieved, for example, during an engine restart of a car, reheating the engine lubricant in a few minutes, to a temperature higher than 15° C. while the outside temperature is very cold, for example, −5 to −10° C., and while the vehicle has been stopped, sitting at this temperature, for example, for 6 to 8 hours, even 10 to 12 hours.

If necessary, the different aspects of the invention will be best understood and other characteristics, details and advantages of it will again appear upon reading the description will follows, produced as a non-exhaustive example and in reference to the appended drawings wherein:

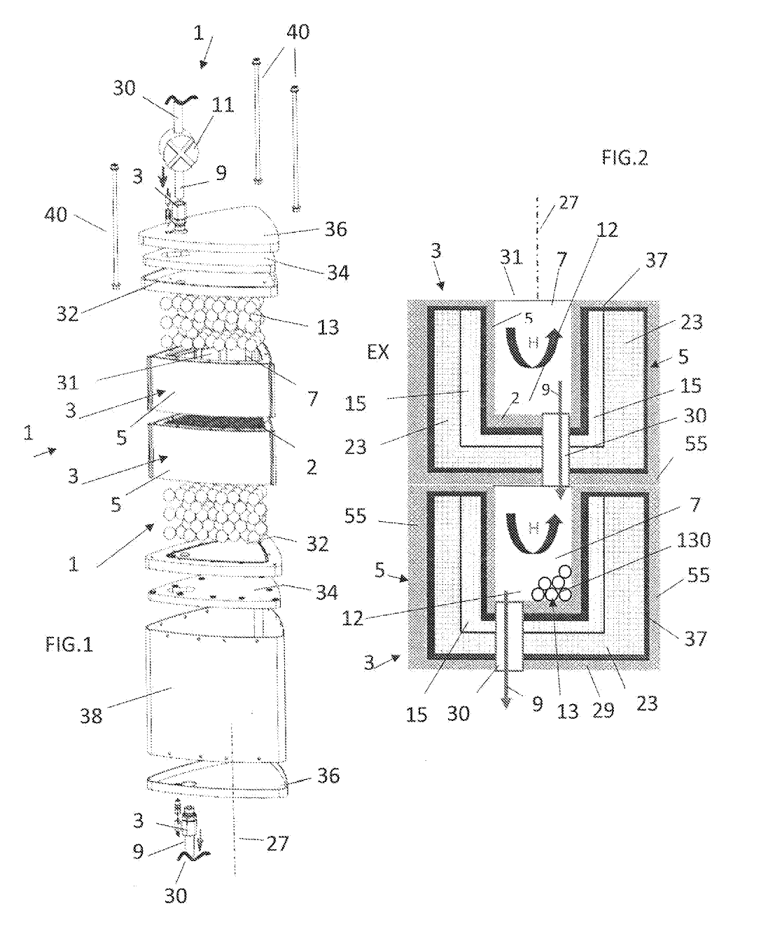

FIGS. 1-4 schematise the application to a store and heat exchanger (FIG. 1) with details regarding the body(ies) which compose it in FIGS. 2-4;

FIGS. 5-6 are cross-sections schematising different ways of producing the PCM/VIP barrier, referenced 15/23 below, within at least one sealed envelope;

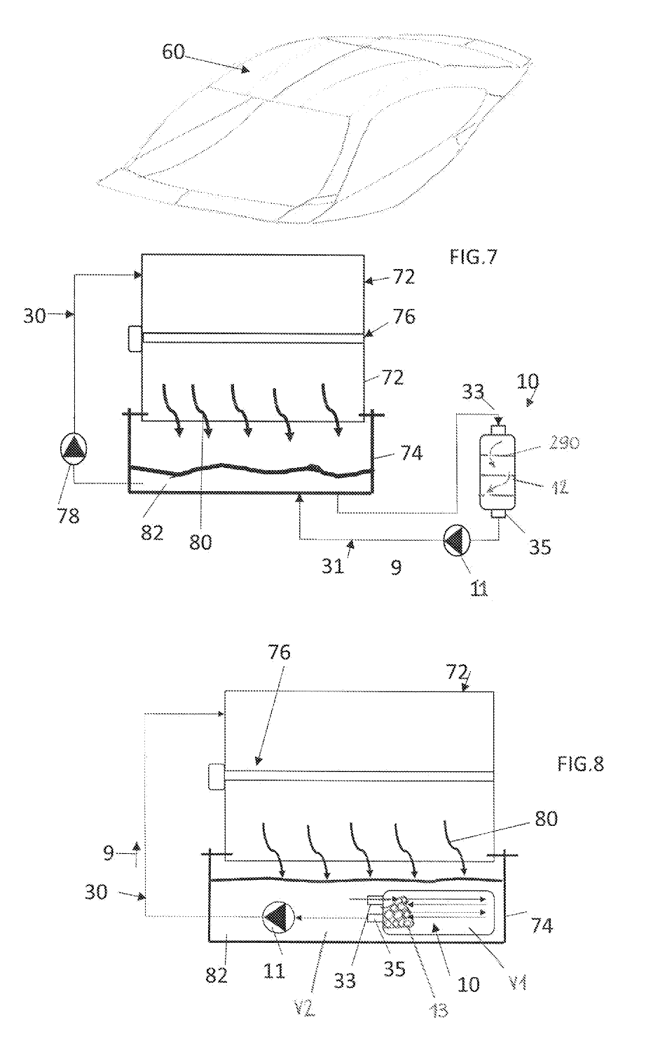

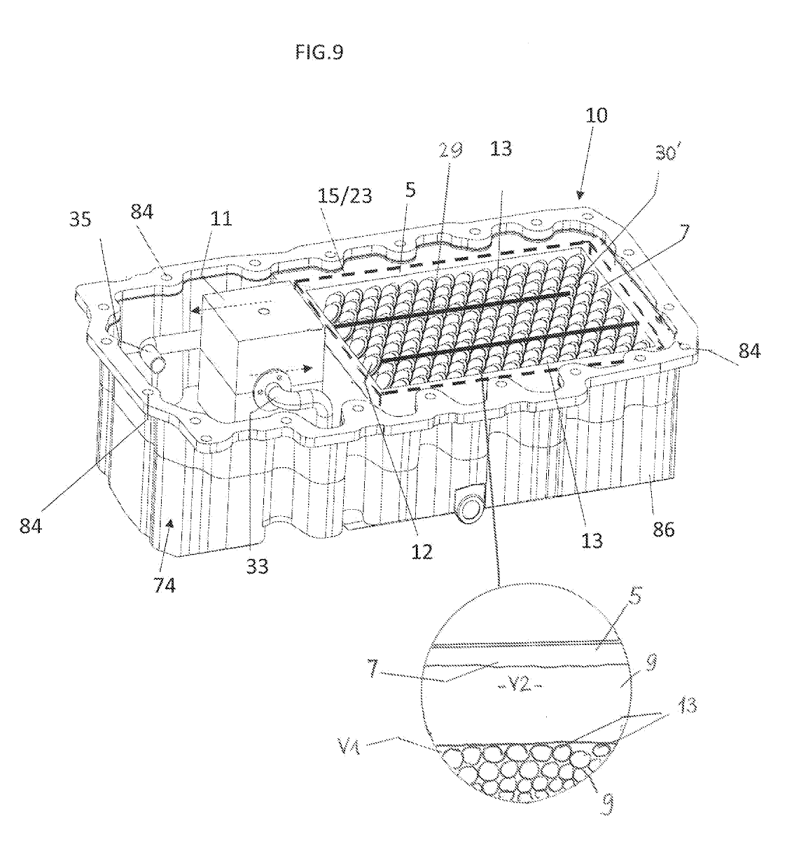

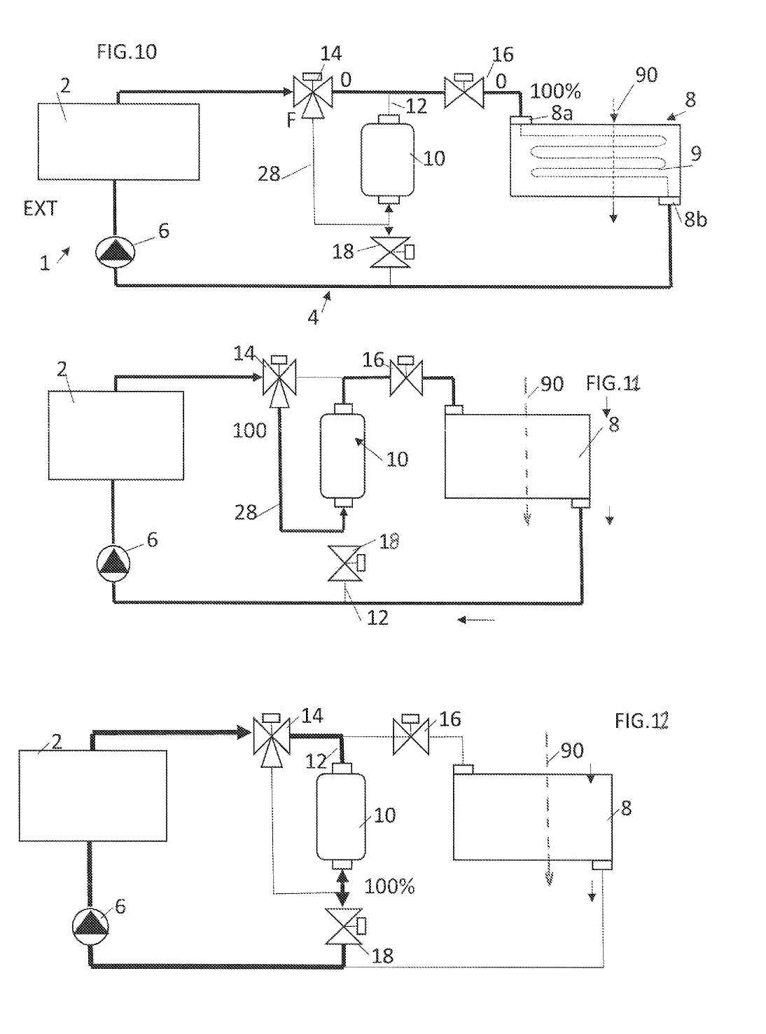

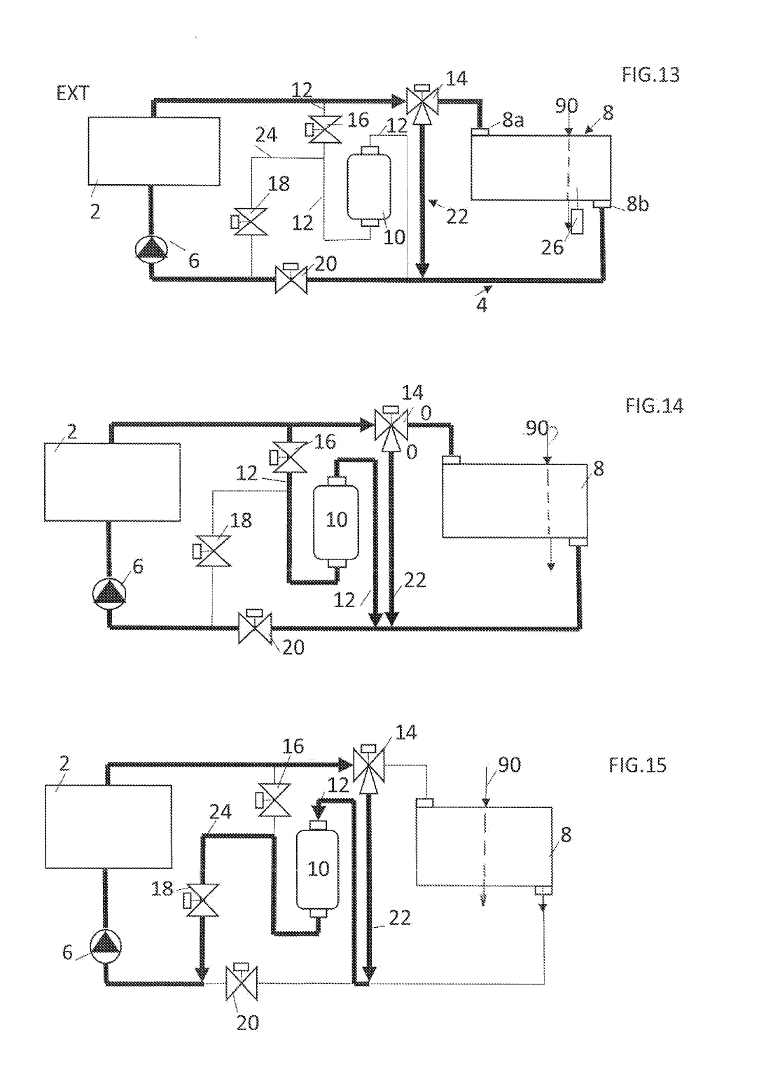

FIGS. 7-9, on the one hand, and 10-17 on the other hand, show two examples of application: two diagrams of lubricant circulation circuits (FIGS. 7,8), with an oil crankcase integrating a store and heat exchanger FIG. 9, and two possible assemblies of a cooling circuit, in series, FIGS. 10-12 and other, FIGS. 13-17,

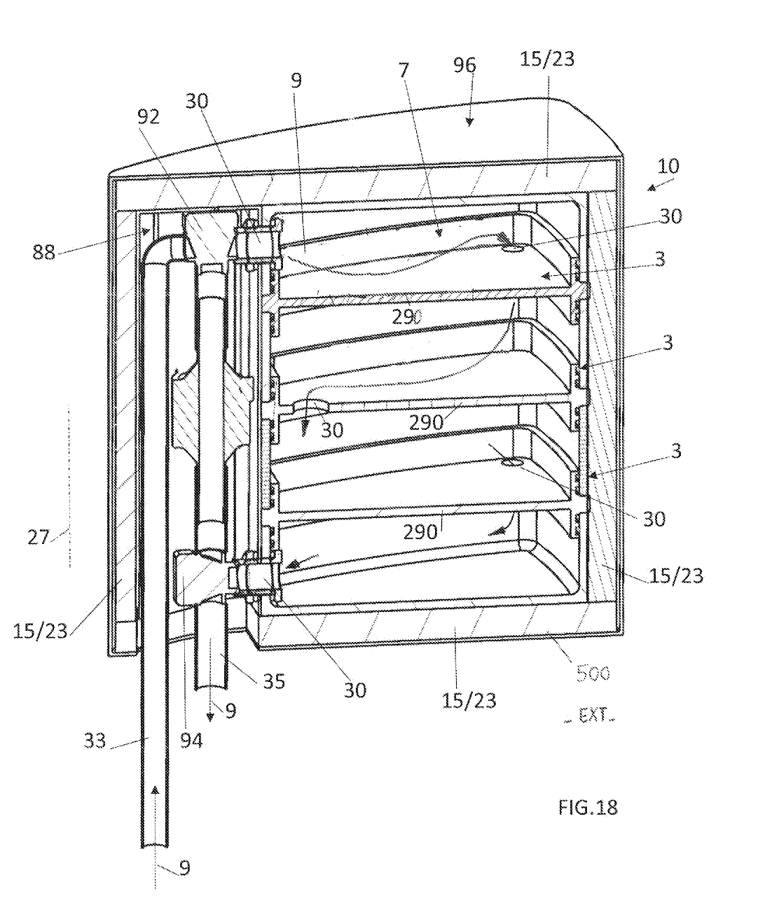

and FIG. 18 schematises a superior functioning of the store/exchanger.

The diagram in FIG. 1 shows a thermal device 1, in which a refrigerant or heat transfer fluid 9 enters and exits, the circulation thereof being ensured here via circulation means 11, such as a pump.

The device 1 comprises:
a circulation circuit 300 of the fluid 9, in which the fluid circulates over time at different temperatures,
and a thermal store and heat exchanger 10 arranged on the circuit 300.

The store and heat exchanger (or unit that stores and releases energy) 10 is a unit which will store thermal energy through phase change(s) of at least one PCM, then later, release a part at least of this energy through new phase change(s) (at least some) of this/these PCM(s).

The store and heat exchanger 10 therefore encloses an interior volume 7, in which the fluid 9 circulates and in which are arranged elements 13 having PCM that store and release thermal energy, and which are in contact with the fluid, for heat exchanges.

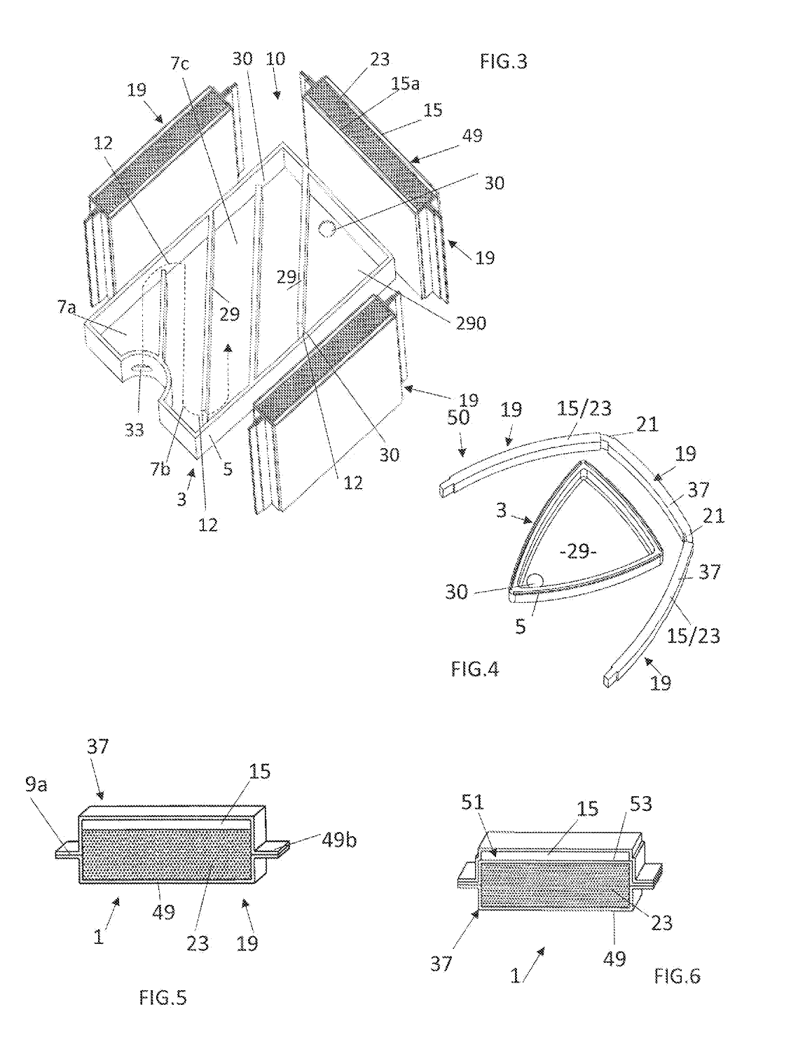

The interior volume 7 of the store and heat exchanger is provided with baffles. To define them, the store and heat exchanger 9 can have, on the fluid path, a series of partitions 29, as in FIG. 3:
which splits the volume 7 into a succession of sub-volumes, such as 7a, 7b, 7c, etc., in which are arranged, by lots, of elements 13 that store and release thermal energy around and/or wherein the fluid circulates, in heat exchanges with them,
and which have, here each one, at least one communication passage 30′ between the sub-volumes.

The fluid 9 circulating in and between the (sub)volumes can be liquid (water, oil) or gaseous (such as air).

So that the figures are legible, FIGS. 2, 3 do not show the elements 13. They can be seen in FIG. 1.

FIGS. 2 and 18 enables to understand that the baffles 12 can only be formed by the fact that the partitions 29 are here bases (290 FIG. 18) of components or modules 3 which are arranged in a line (direction 27), one after the other, in communication two-by-two through a passage 30 arranged in each base 29.

Each module 3 is constituted by a lateral peripheral wall 5 that completes the bored base 29.

Each transversal wall 29 and the crossing passage 30 thereof, thus form a decelerator to the free circulation of the fluid between the inlet 33 thereof and the outlet 35 thereof. Preferably, two successive passages 30 will be laterally offset as schematised. Opposite the base, each module is open, in 31, such that, exiting a passage 30, the fluid arrives directly in the interior volume of the adjacent module. The circulation in the store/exchanger, between the sub-volumes, can be in series or in parallel.

In the variant in FIG. 3, a single body 3 has been designed, with, for example, a lateral inlet 33 through a zone of the peripheral wall 5.

In each case, as constituting the elements 13, a rubber composition such as defined in EP2690137 or in EP2690141 can be provided, namely in the second case, a crosslinked composition with the basis of at least one “RTV” (room temperature vulcanisation) silicone elastomer and comprising at least one phase change material (PCM), said at least one silicone elastomer having a viscosity measured at 25° C. according to the standard ISO 3219 which is less than or equal to 5000 mPa·s.

In this composition, the elastomer matrix will mainly be constituted of one or several “RTV” silicone elastomers. The thermal phase change material (PCM) can be constituted of n-hexadecane, or of a lithium salt, all having melting points of less than 40° C.

As an alternative, the PCM of the elements 13 could be fatty acid-based, paraffin-based, or eutectic or hydrated salt-based, or even fatty alcohol-based, for example.

In particular, for ease with implementing and optimising exchange surfaces, the elements 13 are here presented as individualised structures that have exterior surfaces, here convex, formed to keep a space 130 between them, in which the fluid can circulate (see FIG. 2).

A very favourable solution is thus that these elements 13 are presented as beads. Spherical beads are favoured in the preferred example illustrated. The elements 13 could have crossing passages (bored beads, for example).

In principle, individualised structures 13, here these beads of spheres, will be arranged loosely in the sub-volumes, such as 7a, 7b, etc.

An active thermal barrier (15/23) will favourably ensure a thermal insulation of the store and heat exchanger 10 against the outside.

This active thermal barrier will either be integrated to the lateral peripheral wall 5 (as in FIG. 2), or arranged around (FIGS. 3,4), the barrier comprising at least one first layer 15 containing a PCM and at least one second layer 23 containing a thermally-insulating material.

In principle, the second layer 23 will be, there where the two layers exist and if only two such layers exist, arranged around the first layer 15. Thus, it can be arranged such that an excessively cold or hot outside temperature only slightly interferes with that in the volume(s) 7, the first layer 15 acting as an accumulator/delayer in variation of the temperature in this/these volume(s) and within the fluid.

In order to optimise this process, it is recommended that the active thermal barrier comprises at least one VIP panel forming a pocket 19 in a controlled atmosphere, in which will be arranged at least the second layer 23, it will preferably coexist with the PCM layer 15 within the sealed envelope 37.

The second layer 23 will favourably be a porous, thermally-insulating material, against which the envelope 37 will be sealed. Once the air gap is created in the envelope, a VIP panel will be constituted.

The thermally-insulating material 23 will favourably be composed of a nanostructure material, such as a silica powder or an aerogel, confined in a deformable or conformable sheet which will not let water vapour or gases pass through. The VIP obtained will be emptied of the air thereof to obtain, for example, a pressure of a few millibars, then it can be sealed. Typically, the thermal conductivity A of such a VIP will be 0.004/0.008 W/m·K. Using vacuum insultation panels should enable a thermal resistance R=5 m²·K/W to be achieved, with only 20 to 30 mm of insulator.

The example could be applied here, of VIP panels and superinsulation materials, which are supplied in PCT/FR2014/050267 and in WO2014060906 (porous material), respectively.

The solutions presented above must enable, in an acceptable volume and weight, in particular by aircraft or automotive manufacturers, a quick storage of thermal energy available after around 6-10 minutes, maintaining this energy for 12 to 15 hours, before the quick release thereof, typically for a few minutes (in particular, less than 2/3 minutes), for example, to an engine during a cold start phase.

It is also recommended that thus designed, the store/exchangers 10 will favourably meet the need to introduce size parameters such as RTD (resident time distribution) in the blocks and NTU (number of transfer units/blocks) to facilitate a change in scale without modifying the thermal and hydrodynamic elements obtained during a qualification. With an identical reproduction of a flow in volumes 7a, 7b, etc. of different sizes being impossible, except for breaking down a total volume into identical sub-elements, the solutions above can enable to consider without the effects in scales of identical PCM loading and unloading kinetics.

To complete their fulfilment, FIG. 1 shows, at the ends and axially (direction 27), on either side of the stack of components or modules 3, the presence of a cover 32 on the side of each opening 31, which can be lined with a single pocket 34 of VIP constitution. And a protective plate 36 can close everything, along the axis 27, as illustrated. A connecting sleeve, protective casing or sheath 38 open at the two ends, for example, made of hard plastic, can further surround the modules 3 and the parts 32, 34, 36. The attachment means 40, which can be tie rods, mechanically attach the modules together, along the stacking axis 27.

Like in the embodiments illustrated, each body 3 will favourably be one-piece. It can be made from plastic, metal (stainless steel, aluminium) or composite, in particular. A moulded production will be preferred. In this case, it is provided that the peripheral wall 5 contains a mouldable polymer material (for example, a polyamide or a poly(p-phenylene sulphide, fibre-charged or not), in which the first and/or second layers 15, 23 can be integrated, as provided in the embodiment in FIG. 2, in which the two layers 15, 23 are integrated to the walls 5 and 29.

The reference to a body made from mouldable material covers thermoplastic resins that are fibre-charged and injected, and also thermosetting resins, impregnating a fabric or a material, such as a woven or non-woven fabric.

Integrated or not in the wall of the components 3, at least the second insulating layer 23, and preferably the two layers 15/23, will favourably be vacuum surrounded in one or several pockets 19 therefore known here as “VIP-constituted” (being specified that the partial gap could be replaced by a “controlled atmosphere”: the volume would be filled by a gas that has a thermal conductivity of less than that of ambient air, 26 mW/m·K).

In this regard, pockets, structurally separate from each other, as in FIG. 3 (in which they can be imagined as totally closed at the periphery) or produced like a strip 50 that has a succession of such pockets successively brought together two-by-two by flexible intermediate portions 21 defining articulation zones between two successive VIP pockets 19, as in FIG. 4. The possibility of not having the first nor second layer 15/23 at the place of the base 29 separating two adjacent modules will be noted, via this figure. The advantage of a base 29 with an integrated barrier 15/23 as in FIG. 2, particularly at the end (having a “VIP-constituted” pocket 34), other than that, standardises the manufacture thereof, by reducing the number of parts and makes each module totally thermally autonomous, while optimising heat transfer via the PCM layer 15.

In FIGS. 5, 6, two embodiments have been schematised, among several others, producing a pocket 19. To form a strip 50, it will have been understood that the model then will need to be reproduced, on both sides, to continue the structure, if so desired.

Even if one single PCM (based) layer 15 is represented as in FIGS. 2, 5, 6, two layers 15a, 15b (at temperatures for changing different states from one to the other) surrounding the insulating layer 23 can be provided, as in FIG. 3.

Each pocket 19 comprises:
at least one first element, or first layer 15, therefore containing the PCM, to the side of which is arranged the second layer made from an insulating material 23 (porous, if there is a gap), and
at least one closed exterior envelope 37 which contains the first and second elements and is constituted of at least one deformable or conformable sheet 49, sealed against the PCM, with:
   a) either said sheet 49 which is additionally sealable (thermally/chemically, in 49a, 49b around the pocket), as shown in FIG. 5;
   b) or the second thermally-insulating element 23 contained inside a second closed envelope 51 with flexible sheet(s) 53, which are sealable and sealed against the porous material, as shown in FIG. 6.

The sheet(s) or film(s) 49 and 53 can typically be made as a multilayer film comprising polymer films (PE and PET) and aluminium in laminated form, for example (sheet that is around ten micrometres thick) or metal form (vacuum deposit of a film that is a few dozen nanometres thick).

Two examples of application will now be given, in line with FIGS. 7-9 on the one hand, and 10-17 on the other hand. Generally, and even if other fields are not excluded, such as construction or industrial refrigeration, the applications below relate to the field of vehicles that move engines, in the automotive (cars, lorries, etc.), aeronautical and maritime (surface ships, submarines, various floating craft, etc.) fields, in particular.

Thus, a vehicle 60, such as a car, can be seen in FIG. 7, comprising the circuit 300 mentioned above, which is here, on an engine 72 of the vehicle, a lubrication circuit whereon are arranged, in fluid communication, functional components 76 of the engine to be lubricated, a lubricant crankcase 74 and the thermal store and heat exchanger 10 which can therefore comprise one or several modules 3, as schematised in FIGS. 3 and 1, respectively. Below, the lubricating fluid (9 above) is oil, for example.

FIG. 8 shows an alternative embodiment.

In the two cases, the circuit 300 defines a path for circulating a fluid whereon are arranged, in fluid communication with each other, an oil crankcase 74 and functional components of the engine to be oiled, such as connecting-rod bearings and crankshaft bearings, but also the camshaft and the drive device 76 thereof. The crankcase 74, of which the tank (metal, in principle) is screwed under the engine block 720, with a seal, contains the oil necessary to lubricate the mobile elements of the bottom-engine and the top-engine. Oil is drawn here by the suction strainer of the oil pump 78 which distributes it under pressure, preferably via an oil filter, to the different components (crankshaft, connecting rods, camshaft, etc.). The oil can then sink simply through gravity; arrows 80.

In the version in FIG. 7, the store and heat exchanger 10, which can be that of FIG. 1, assembled, is connected via the connector 33, 35 to the branch 310 of the circuit 300 which communicates with the oil bath 82 of the crankcase 74. The pump 11 ensures the circulation of oil in the unit 10 and the branch 310. Thus, the oil bath 82 will be able to benefit from oil at a suitable temperature, such as a temperature avoiding, in particular, a temperature that is too low in winter (see above, the reference to a cold start). Another pump 78 removes the oil in the bath to distribute it to the components related to the engine, via the branch 301 of the circuit 70. This solution can be adapted to a lubrication “by dry crankcase”. The oil will thus no longer be contained in the crankcase, but in a separate tank, where it will be directly drawn, before going in the unit 10, to then be routed to the points to be lubricated, the return being made directly in the tank.

In the second assembly, schematised in FIG. 8, the store and heat exchanger 10 is placed via the inlet/outlet connector of fluid 33, 35 directly on the closed oil circuit 300 which goes through the components mentioned above relating to the engine 72 and the crankcase 74. The pump 11 ensures the circulation of oil in the unit 1 and the whole circuit 300. The unit 10 is arranged in the oil crankcase 74. The oil thus goes from the bath 82 into the unit 10, from where it is removed to circulate to said components to be lubricated. Such an integration enables space gains, even weight and rate gains (potentially less loss of load and thermal protection which can again be accumulated by insulating the wall of the crankcase 74).

In FIG. 9, a possible assembly has been schematised, in the crankcase 74, of the store and heat exchanger 10, of the means 11 for circulating the liquid and the inlet/outlet connector of fluid 33, 35 to connect directly on the closed oil circuit (not represented). The orifices 84 of the crankcase enable the assembly thereof under the engine block.

The store and heat exchanger is almost that of FIG. 3, with one single module compartmentalised into sub-volumes and baffles 12 via partitions 29 which define the sub-volumes, with communications 30′ between them. Thus, the fluid is obligated to weave in the volume 7, in which are arranged the elements 13 having PCM that store and release thermal energy. By circulating around and/or in the elements (13) that store and release thermal energy which are distributed in the sub-volumes (7, 7b, etc.), the lubricant will thermally exchange with them.

Laterally all around, but also under and above it, via, for example, crankcase covers such as that 32 with a single or multiple pocket(s) and VIP-constituted 34 (as in FIG. 1), the volume 7 is provided from the thermal management complex with PCM layers 15, thermally-insulating layers 23 and with pockets 19. In practice, the walls 5 constituting the store and heat exchanger 10 can, for that, be provided, for example, integrated in their thickness or in the lining, one known thermal management complex with PCM layers 15, thermally-insulating layers 23 and with vacuum pockets 19, as schematised in FIG. 9.

In principle, the internal volume of the crankcase 74 will be fixed by the manufacturer of the vehicle.

Yet, producing a vehicle lubricant tank which could enable to heat the lubricant while the outside temperature is very cold, for example, −5 to −10° C., and while the vehicle has been stopped, sitting at this temperature, for example, for 6 to 8 hours, was a challenge.

A solution has been given here, by providing both, favourably, and as schematised in FIGS. 8 and 9:
in the lubricant crankcase 74, circulation of lubricant when stopped, the elements 13 that store and release said thermal energy (see extracts in FIGS. 8, 9) are immersed in a first lubricant volume (V1) outside (typically above) which lays a second lubricant volume (V2) bigger than the first volume,
and that the baffles 12 are present in the volume 7 filled with said elements 13.

In particular, during an engine start, the PCM(s) of said elements 13 will thus still be hot: they will have kept the latent heat coming from the end of the previous functioning of the engine block provided from said lubricant crankcase. The first lubricant volume (V1) will therefore be hotter than the second (V2), by heat exchange with the elements 13 immersed in it.

But, the second exterior lubricant volume (V2) being constructed bigger than the first volume (V1), it has been chosen to multiply and extend the fluid/PCM exchange zones, from there the baffles 12 via an internal partitioning which is schematised in FIG. 8 by weaving arrows and via the partitions 29 in FIG. 9.

In this way, at the time of starting a new cycle (after stopping mentioned above by cold time), by progressive mixing via circulation in the circuit, the total lubricant in circulation (V1+V2) can quickly be hot throughout, with advantages in terms of rate of the engine to be lubricated and limitation of pollutants.

In the enlarged extract in FIG. 9, it is assumed that the volumes V1+V2 are only contained in the volume 7, the volume V1 in the lower part containing the PCM elements 13, and that it sits on top of the volume V2, and which is less than this second lubricant volume (V2), outside of the zone containing said PCM elements 13. In this event, the PCM element 13 fill level of the unit is wrong at the top of FIG. 9.

In FIGS. 10 to 17, the circuit 300 is a circuit for cooling with a heat transfer liquid (9 above), such as water, a vehicle engine 2.

The circuit comprises a path 4 for circulating the liquid and, arranged on the path:
in series, a means 6 for circulating the liquid on a path, the engine 2 of which the components are to be placed in heat exchange with the liquid 9 which circulates and a radiator 8 that has a liquid inlet 8a and a liquid outlet 8b in order to place it in heat exchange with another fluid 90,
assembled on a first branch 12, between the inlet and outlet of the radiator, the thermal store and heat exchanger (or unit) 10.

The term radiator includes:
both a general automotive or aeroplane radiator of the (air) fluid/liquid (glycoled water) exchanger type,
that the liquid/liquid exchangers as on maritime structures, such as boats, in which the radiator will typically be a liquid (seawater)/liquid (freshwater) exchanger.

In addition, two assemblies of the circuit are possible: FIGS. 10-12 or FIGS. 13-17. In these figures, the bold lines show where the fluid circulates, the fine lines show where it does not circulate.

With the assembly in FIGS. 10-12, the operating mode is as follow, the valves below typically being automatically-controlled solenoid valves (the same for the other assembly):
in nominal functioning (FIG. 10) and exiting the engine 2, the liquid goes into the first three-way valve 14 and then exclusively into the radiator 9, without going into the unit 10, the second (two-way) valve 16 being open and the third (two-way) valve 18 closed,
in a situation of the unit 10 being loaded with thermal units (FIG. 11) and exiting the engine 2, the liquid goes into the first valve 14 which exclusively directs towards the unit 10 (via the second branch 28 of the circuit) after which the liquid goes into the radiator 8 then returns to the engine, the second valve 16 being open and the third valve 18 closed,
and, in a situation of the unit 10 being unloaded of thermal units (FIG. 12), the liquid goes into the first valve 14 and then exclusively into the unit 10, then returns to the engine 2, the second valve 13 being closed and the third valve 18 open.

With the assembly in FIGS. 13-17, the operating mode is as follows:
in nominal functioning (FIG. 13) and exiting from the engine 2, the liquid goes into the first three-way valve 14 and then into the radiator 8, without going into the unit 10, the fourth (two-way) valve 20 being open and the second and third (two-way) valves 16, 18 closed,
in a situation of the unit 10 being loaded with thermal units (FIG. 14) and exiting the engine, the liquid goes at least in part into the second valve 16 which (via the first branch 12) directs it towards the unit 10, while passing towards the radiator 8, through the first valve 14, and into the second branch 22 is adjusted according to at least one physical parameter in the unit and in the radiator 14, after which the liquid returns towards the engine 2, the fourth valve 20 being open and the third valve 18 closed,
in a situation of the unit 10 being unloaded of thermal unit (FIG. 15), the liquid goes into the first valve 14 which directs it exclusively into the unit 10 by the second branch 22 then the first branch 12, without passing into the radiator, the fourth valve 20 being closed, after which the liquid returns towards the engine 2, the second valve 16 being closed (still like the fourth valve 20) and the third valve 18 opens such that the liquid can go into the third branch 24 supporting the third valve 18 and connected:
   on one site, on the branch 12, between the second valve 16 and the unit 10,
   on the other side, on the path 4, between the inlet in the engine and the fourth valve 20.

Preferably, the physical parameter to choose in the unit 10 and the radiator to control the loading of thermal units, more or less quickly or completely from the unit 10 will be a temperature in the radiator 8, preferably an exit temperature.

And, favourably, in nominal functioning, the first valve 14 will distribute, between the radiator 8 and said second branch 22, the circulation of the liquid exiting the engine according to temperature data connected to the radiator. A temperature sensor 26 is provided for this (FIG. 13), connected to the calculator which controls the valves.

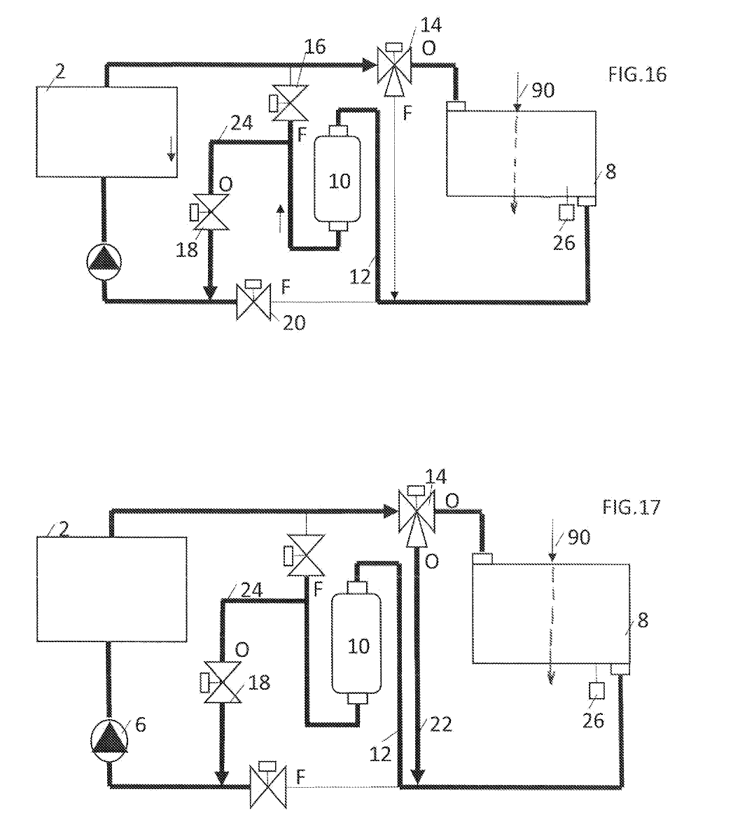

Furthermore, in nominal functioning, if a power problem occurs on the radiator 8 due to a thermal overload detected by a temperature sensor (such as the sensor 26), the fourth valve 20 will close and the third valve 18 will open, to ensure a circulation of liquid in the unit 10 (via the first branch 12) after passing into the radiator (FIG. 16). The second valve 16 will be closed, the return towards the engine occurring via the third branch 24 (in which the third valve 18 is always open), the fourth valve 20 always being closed.

Then (see FIG. 17), once the temperature sensor will detect an end of thermal overload in the radiator 8, the first valve 14 will again distribute the circulation of the liquid exiting the engine 2 between the radiator 8 and said second branch 22, whereas it had directed the liquid exclusively towards the radiator, without therefore passing into the second branch, after detecting the thermal overload by the temperature sensor.

Concerning the thermal efficiency of the unit 10 in one of the circuits, it will again be noted that the/each unit module can be thermally-insulated from the outside (EXT) by the barrier complex 15/23 favourably comprising an aerogel VIP 23 of thermal conductivity equal to 6-8 mW/mK at 25° C., 15-20 mm thick surrounding an elastomer-based layer 15 loaded with 80-90% by PCM mass, enthalpically microencapsulated equal to 200-240 kJ/kg, 2.5-5.5 mm thick. The initial quantity of stored energy of 1.5-2 MJ for the oil can be maintained with a SOC (state of charge) at 65-75% above 15 hours, thus enabling the release of very efficient new energy. This energy can be released in less than 2/3 minutes to maximise the reduction of CO₂ emission in the case of a cold start of the engine, for example.

Regarding FIG. 18, it schematises a superior functioning of the store and heat exchanger 10. Here, there are several superimposed modules 3 each enclosing an interior volume 7 in which the fluid 9 can circulate, between the inlet 33 and the outlet 35. Each module has a base 290 and can be opened opposite. The bases 290 create a succession of sub-volumes, in which are arranged series of elements 13 (not represented here) in contact with said liquid and along which the liquid circulates. Passages 30 make the module volumes communicate, parallel to the superposition axis 27 (here vertical). Two successive passages are laterally offset (in relation to the axis 27). This creates baffles. A functionalised column 88 extends along the axis 27, outside of the superimposed modules. It comprises inlet 33 and outlet 35 connectors (tubes), their connections to the first and last modules of the stack and two valves 92, 94. The three-way valve 92 directs the entering fluid, either towards the first module 3, or directly towards the outlet tube 35 which itself is parallel in the column 88. The second valve 94, two-way, forbids or enables the communication between the volume of the last module and the outlet tube 35, downstream of the valve 92. There is no PCM layer, nor thermal insulator between the modules in the place of the bases 290 in which the passages 30 are arranged.

All the superimposed modules 3 (even as here, the functionalised column 88 arranged opposite them), without therefore interfering with their internal volumes, are surrounded by the peripheral wall 500 of a protective casing 96 containing or lined inside, on all faces of the casing and almost continually, for the thermal management complex 15/23 having PCM and VIP pockets in a controlled atmosphere, 19 or 50.

1. Thermal device for a refrigerant or heat transfer fluid, the device comprising:
a circuit for circulating said fluid, in which the fluid circulates over time at different temperatures,
a thermal store and heat exchanger arranged on said circuit and enclosing an interior volume:
in which only the fluid circulates, between an inlet and an outlet,
and in which PCM is arranged, for a heat exchange with said fluid which is the only one to circulate between each other,
characterised in that:
the PCM is arranged, within said interior volume, in a plurality of elements that store and release thermal energy,
of modular construction, the thermal store and heat exchanger comprises several adjacent modules, structurally separate and of which at least some individually comprise a base separating two adjacent modules, each base:
splitting the volume into a succession of sub-volumes, in which are arranged said elements that store and release thermal energy, around and/or wherein the fluid circulates, in heat exchanges with each other,
and having at least one passage for communicating between the sub-volumes, and,
for creating baffles in thermal store and heat exchanger on the fluid path:
passages for communicating between the sub-volumes are offset from a following passage, and/or
inside the corresponding module, and for creating other sub-volumes there, partitions stand which keep communications between said other sub-volumes, for the circulation of the fluid.

2. Thermal device according to claim 1, in which the elements that store and release thermal energy are individualised structures that have exterior surfaces formed to keep a space between two of said elements, in which space the fluid can circulate.

3. Thermal device according to claim 1, in which the elements that store and release thermal energy comprise beads.

4. Thermal device according to claim 1:
in which the store and heat exchanger has at least one peripheral wall interleaved between the interior volume of the outside, and
the device further comprises at least one first layer containing a PCM and at least one second layer containing a thermally-insulating material which surrounds said interior volume.

5. Thermal device according to claim 4, in which said at least one peripheral wall contains a mouldable polymer material and the at least one first and second layers are integrated with said polymer material.

6. Thermal device according to claim 4, in which said at least one peripheral wall belongs to an exterior protective casing surrounding all the modules of the store and heat exchanger and which integrates or is lined by said at least one first and second layer(s).

7. Thermal device according to claim 4, in which each one of the modules of the store and heat exchanger comprises said peripheral wall which integrates or is lined by said at least one first and second layer(s).

8. Thermal device according to claim 1, in which the circuit is a circuit for cooling by a heat transfer liquid, such as water, an engine on a vehicle, the circuit comprising a path for circulating the liquid and, arranged on the path:
in series, a means for circulating the liquid on the path, an engine of which components are to be placed in heat exchange with the liquid and a radiator that has an inlet and an outlet for said liquid in order to place it in heat exchange with another fluid,
assembled on a first branch, between the inlet and the outlet of the radiator, the thermal store and heat exchanger according to one of the preceding claims.

9. Thermal device for a refrigerant or heat transfer fluid, the device comprising a circulation circuit, in which a fluid circulates over time at different temperatures, and which, on a vehicle engine, is a lubrication circuit whereon are arranged, in fluid communication, functional components of the engine to be lubricated, a lubricant crankcase and a thermal store and heat exchanger, wherein said fluid only circulates,
the thermal store and heat exchanger including:
an interior volume:
in which the lubricant circulates, between an inlet and an outlet,
and in which are arranged, a plurality of elements having PCM, and that store and release thermal energy,
in said interior volume, partitions which split the volume into a succession of sub-volumes with communications between them, for the circulation in baffles of the lubricant, around and/or in the elements that store and release thermal energy which are distributed in the sub-volumes, to thermally exchange with the lubricant,
and, in the lubricant crankcase, with lubricant circulation stopped, said elements that store and release said thermal energy are immersed in a first lubricant volume outside which a second lubricant volume lays superior to the first volume.

10. Thermal device according to claim 9, in which, around said interior volume, at least one layer containing a thermally-insulating material is contained in an envelope sealed against the material and against air, such that with an air gap being created in said envelope, a VIP panel is constituted.

11. Thermal device according to claim 9, in which:
the functional components of the engine are located in an engine block,
the lubricant crankcase is screwed to the engine block, under said engine block, and contains a lubricant bath, and
the thermal store and heat exchanger is arranged in the lubricant crankcase, to send the lubricant towards the engine block, after which it has circulated in said thermal store and heat exchanger.

12. Motor vehicle comprising a thermal device for a lubricating fluid, the device comprising a lubrication circuit, in which the lubricating fluid circulates over time at different temperatures, and whereon are arranged, in fluid communication:
functional components of the engine to be lubricated, located in an engine block,
a lubricant crankcase screwed to the engine block, under it, containing a lubricant bath,
and a thermal store and heat exchanger including an interior volume wherein only the lubricant circulates, between an inlet and an outlet, a plurality of elements having PCM, and that store and release thermal energy, being arranged in the interior volume, which is split by the partitions into a succession of sub-volumes with communications between the sub-volumes, for the circulation in baffles of the lubricant, around and/or in the elements that store and release thermal energy which are distributed in said sub-volumes, to thermally exchange with the lubricant, the thermal store and heat exchanger being arranged in the lubricant crankcase, to send the lubricant towards the engine block, after it has circulated in said thermal store and heat exchanger.

13. Lubricant crankcase connected to a circuit for lubricating a vehicle engine whereon are arranged, in fluid communication, said lubricant crankcase and functional components of the engine to be lubricated, located in an engine block, characterised in that:
the lubricant crankcase contains a thermal store and heat exchanger wherein only said lubricant circulates, before which it is sent towards the engine block, said thermal store and heat exchanger including the interior volume, wherein only the lubricant circulates, between an inlet and an outlet, a plurality of elements having PCM, and that store and release thermal energy, being arranged in the interior volume, which is split by partitions into a succession of sub-volumes with communications between the sub-volumes, for the circulation in baffles of the lubricant, around and/or in the elements that store and release thermal energy, which are distributed into said sub-volumes, to thermally exchange with the lubricant,
and, with the lubricant circulation stopped, the lubricant crankcase contains a first lubricant volume and a second lubricant volume, said elements that store and release said thermal energy being immersed in said first volume outside of which lays, in the lubricant crankcase, the second lubricant volume which is superior to the first volume.

14. Motor vehicle comprising a thermal device for a lubricating fluid, the device comprising a lubrication circuit, in which the lubricating fluid circulates over time at different temperatures, and whereon are arranged, in fluid communication:
functional components of the engine to be lubricated, located in an engine block, and
the lubricant crankcase according to claim 13, which is screwed to the engine block, under it, and which contains a lubricant bath, in which the thermal store and heat exchanger is arranged.
